(19) United States
(12) Patent Application Publication
(10) Pub. No.: US 2014/0112469 A1
(43) Pub. Date: Apr. 24, 2014

(54) Novel encryption processes based upon irrational numbers and devices to accomplish the same

(71) Applicant: John M. Layne, Saint Johns, AZ (US)

(72) Inventor: John M. Layne, Saint Johns, AZ (US)

(21) Appl. No.: 13/573,057

(22) Filed: Oct. 22, 2012

(51) Int. Cl. H04L 9/00

(52) U.S. Cl. 380/44

(57) ABSTRACT

Encrypting a clear text by: providing a computer; using the computer to provide: a True Random Number table (TRN table); a Hyper-Key Identification table (Hyper-Key ID table); and a Key Identification position number (Key ID position number); using the Key ID position number to choose a Hyper-Key Identification (HKID) number; using the HKID to generate Hyper Keys; providing a clear text message to be encrypted; using a Hyper Key, Xor Hyper Encrypting the clear text file and the Hyper Key to produce a first level Crypt text file; using a second Hyper Key, Bit Scrambling the first level Crypt text file and the second Hyper Key to produce a second level Crypt text file; and using the second level Crypt text file, Null Bit Padding the second level Crypt text file to produce a third level Crypt text file.

### FIELD OF THE INVENTION

The present invention relates to a novel encryption/decryption processes based upon irrational numbers and devices to accomplish the same. More specifically, the novel process utilizes a portion of an irrational number, which is by definition non-periodic.

### BACKGROUND

As the world becomes increasingly dependent on computers and data transmission, vast amounts of communicated data need to be secure from unauthorized access. Cryptographic encryption, which concerns the secure transmission of information by transformation of the intended message into a form only understood by the intended recipient, is increasingly used to prevent unauthorized access. In cryptographic encryption, an original message, M, also referred to as a plaintext message, is represented by a finite string of symbols from a given alphabet, S. The encryption procedure codes the plaintext message into an encrypted ciphertext message, C, using an encryption transformation, E, that depends on a set of parameters, K, called the key. The resultant encrypted ciphertext message should be meaningless to an unintended observer.

The encryption transformation is a cryptographic algorithm, i.e., a set of rules or steps that encompasses enciphering T and deciphering D functions using the cryptographic keys K. For example, encrypted ciphertext can be represented as C=T(M,Kₑ). The recipient of the ciphertext can recover the underlying plaintext message from the ciphertext by employing a decryption algorithm, which can be generally represented as D(T(M, Kₑ), K_{d})=D(C, K_{d})=M.

In a symmetric cryptosystem, the deciphering algorithm is the same algorithm as the enciphering algorithm and encryption-decryption become C=T(M, K) and D(C, K)=M; Kₑ=K_{d}=K. Therefore, for the message is to be successfully interpreted, both the sender and recipient of the message must share the same key. In asymmetric, or public-key, cryptography, one of the keys, usually the encryption key Kₑ, is made public and the other key, usually K_{d}, is kept private and encryption-decryption become C=T(M, Kₑ) and D(C, K_{d})=M; Kₑ≠K_{d}.

In the past, cryptography was used primarily within the military, intelligence, and diplomatic communities. With the increased speed and facility of data transfer provided by modern computer systems and information superhighways, cryptographic applications have begun to appear in banking, administration, computer networking, counter-narcotics activities, and ordinary electronic mail applications.

The emergence of these new cryptographic concerns in non-traditional areas has led to the development and use of several iterated cryptosystems. Generally, an iterated cryptosystem relies upon the stepwise application of weak functions to produce a cryptographically strong result. Iterated cryptosystems are useful since many encryption methods individually are not strong enough to produce secure, strong results. However, when these methods are applied in series very good results may be achieved.

Currently the most popular iterated cryptosystem is the Data Encryption Standard (DES). The DES was adopted by the National Bureau of Standards in 1977. The DES, along with a large number of cryptosystems inspired by it, survived attack attempts for several years. However, differential cryptanalysis has been used effectively in recent years to attack these systems. These attacks exposed design flaws in many of the iterated cryptosystems. One such design flaw is that the time required to defeat some iterated encryption techniques can by reduced to a matter of minutes, or even seconds, on personal computers. The revelation of these exploitable weaknesses increases the need for alternative cryptosystems.

One way to avoid problems that arise using iterated cryptosystems is to develop a cryptosystem that works from a strong foundation. A one-time pad is an example of such a cryptosystem. The one time pad requires a unique and random string K as the keyspace. Encryption of the plaintext messages is achieved by combining the plaintext message string and the random string by some bitwise mechanism, for example, the ciphertext C can be defined as the exclusive-or (XOR) product of M and K. The XOR operation is completely defined by the following set of rules: 0:0=0; 0:1=1; 1:0=1; 1:1=0.

Applying the XOR operation, M and K are first converted into binary code. The binary codes representing M and K are then XORed bit by bit until the complete binary code of the ciphertext is produced. The ciphertext can then be converted to the plaintext message by XORing the ciphertext and the key. According to these rules, a second application of the XOR operation will reproduce the original number. This is the key feature permitting conversion of M to C and back to M based upon K. Since the distribution of an ideal K is random and uniform (and independent of the distribution of M, any attempt to decrypt C, without knowledge of K, has only a minimal chance of success.

Proper application of the one-time pad entails security requirements that greatly limit its practicality. First, the one-time pad requires the secure distribution of at least as much key material as plaintext. Second, a new random string must be used for each encryption, as attacks employing multiple ciphertexts encrypted under the same key are trivial. The impracticalities associated with these two requirements are referred to as the key management problem.

Fortunately, construction of an absolutely unbreakable code is unnecessary to achieve effective data security. What is necessary is that the work involved to break the code be so great that the time, effort, and money expended is greater than the possible reward for success. To achieve an acceptable level of security, while simultaneously reducing the nightmare of distributing the key to the intended recipient, a method of generating a truly random sequence based on a small set of initial conditions is needed.

Random number generators today produce pseudo random sequences that are useful for cryptography only if they are sufficiently random and they are secure. To be secure, an attacker should not be able to determine future values of the sequence based on past values, nor be able to determine the initial values based on the corresponding sequences produced. To be random, the sequences should be noise-like and aperiodic or nonrepeating.

An ideal random number generator would produce a truly random sequence. However, this is impossible since the generation and analysis of a truly random sequence are not feasible in finite time. An actual generator can, therefore, produce only a pseudo random sequence for which various measures of randomness can be defined. For practical use in a given application, a pseudo random number (PRN) generator should desirably possess: (i) reproducibility, (ii) computational efficiency, and (iii) adherence to standards related to that specific application.

To insure security against cryptographical attacks, a purely statistical notion of randomness must be avoided and a more cryptographically oriented definition must be adopted. Any statistical benefits incurred from a particular PRN generator that are not directly associated with its adherence to a cryptographic definition of randomness are cosmetic, and add little to the generator's usefulness. A cryptographically strong pseudo random number generator (CSPRING) must produce sequences of values which: (i) possess minimal internal correlation, (ii) convey minimal critical information regarding their origin, and (iii) are absolutely dependent upon unique and sensitive initial conditions for proper reproduction.

Minimal internal correlation requires that a sequence of PRNs must possess an acceptably small correlation between subsequent values and close neighbors. Furthermore, long range correlations (periodicity) are equally undesirable since the existence of such correlations can offer information regarding the nature of the algorithm used to produce the sequence.

One method used to generate pseudo-random like numbers utilize algorithms from the branch of mathematics known as chaos. Using chaotic dynamics, periodic sequences can be utilized that have such long cycle times that they appear aperiodic in a region of interest. In other words, when operating in a chaotic region, a periodic sequence can be produced with cycle length approaching infinity. This is important to prevent an attack based on information contained in the periodicity.

A particular cryptographic technique based on chaos theory is presented in U.S. Pat. No. 5,048,086 to Bianco et al. (Bianco), the disclosure of which is incorporated herein by reference. Bianco used the logistic difference equation: Xₙ₊₁=μxₙ (1−xₙ), to produce random sequences that appear aperiodic. The logistic difference equation is a nonlinear function that is chaotic for certain values of which is a constant and ranges between 0.0 and 4.0. The unique sequences produced by selection of an initial xₙ, selected between 0.0 and 1.0, are very sensitive to small changes in the initial value of xₙ. In other words, there is very little correlation between a small change in initial conditions and the output produced by that initial condition.

Bianco filtered the real number output of the logistic function, which is between 0.0 and 1.0, by limiting it between a preselected upper and lower limit, and converting the result to binary 1's and 0's. Numbers falling between the lower limit and a preselected midrange became 0's, and numbers between the upper limit and the midrange became 1's. The binary sequence was then added modulo-2 to the plaintext message, bit by bit, to arrive at the ciphertext.

The initial conditions used by Bianco to generate the binary sequence are the parameter μ, the upper limit, the lower limit, and an initialization count that determines the number of iterations the program will make before picking a starting point. According to Bianco, the actual values of the binary bit stream (xₙ's) are not obtainable from the filtered data, therefore, it would be computationally infeasible to recover the message or key from the ciphertext.

Another cryptographic algorithm based on chaos theory is presented in U.S. Pat. No. 5,479,513 to Protopopescu et al. (Proto), the disclosure of which is incorporated herein by reference.

Proto utilized two chaotic functions: the same logistic difference function as utilized by Bianco: xₙ₊₁=λxₙ (1−xₙ), where λ=μ; and the Bernoulli shift: Xₙ₊₁=2xₙ mod 1. These two functions are initialized using a key consisting of two 64 bit floating point “seeds” (K₁ and K₂), a 64 bit floating point X in the range of (3.99, 4), and an 8 bit integer (1) (small L) representing the number of iterations between subsequent values in the pseudo random sequence.

The initial seed values K, and K₂, and X, are plugged into the chaotic functions above and the functions are iterated 1 time to produce the first iterate values C₁⁽¹⁾(K₁) and C₂⁽¹⁾(K₂). The first iterates are XORed together to produce a first value R₁. R₁ is a 64 bit XORed product and the byte (8 bits) consisting of bits 48-55 are extracted forming a pseudo random integer value P₁.

The chaotic functions are then iterated again producing second iterate values that are XORed together to form second value R₂. Bits 48-55 are extracted from R₂ to form P₂. This process continues until pseudo random integer sequence P₁, P₂, . . . , pₙ is formed.

The pseudo random integer sequence is then XORed with the plaintext message to generate the ciphertext. The plaintext message is first separated into 8 bit component characters mₙ, such as ASCII representation, to be XORed with the 8 bit pseudo random integers Pₙ. The ciphertext components Cₙ=Mₙ\textcircled{×}pₙ. To decipher, mₙ=cₙ\textcircled{×}pₙ.

Other popular random number generators in use today are based on the linear congruential method, the middle square method, multiplicative methods, and mixed methods. These are enhanced by additional techniques such as data perturbation, swapping random sample queries, cell suppression, partitioning, and complex bitwise manipulation. These methods have met with varying degrees of success in different applications, but they do not provide a definitive answer to random number generation problems.

Although many advances have been made in the science of cryptography, it is apparent that a need continues to exist for the fast and secure transmission of information. The present invention provides such a system.

### SUMMARY OF THE INVENTION

It is, therefore, an object of the present invention to provide a method and system for encrypting information based upon the use of irrational or true random numbers, such that the information can be effectively and securely transmitted and deciphered.

Another object of the present invention is the provision of a method and system for the creation of hyper-strong pseudo-random sequences using portions of an irrational.

A further object of the present invention is to provide a method and system whereby hyper-strong pseudo-random sequences are generated having minimal internal correlation, minimal critical information content, unique initial conditions, and sensitivity to any changes in those conditions.

It is also an object of the present invention to provide a hyper-strong pseudo-random number generator exhibiting reproducibility, computational efficiency, and adherence to standards related to specific applications.

The sequences produced in accordance with the invention fulfill all of the requirements for generating hyper-strong pseudo-random integer sequences. True irrational number systems are nonrepeating. The reproducibility of sequences generated by using the irrational numbers is guaranteed. The computational efficiency of the generator is a result of its recursive nature. A computer-based application performs few operations per iteration, making the generation of long strings of iterates simple and quick. Furthermore, statistical tests show that the output using portions of irrational numbers can be efficiently transformed so as to relate minimal critical information and possess practically no internal correlation.

Accordingly, it is an objective of the present invention to produce hyper-strong pseudo-random numbers, based on irrational number systems, to generate keys for use in a cryptographic system.

It is still a further objective of the present invention to provide a cryptographic system that can be written in any computer language and operates on any computer, microprocessor, processor chip, or any other electrical device.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWING

FIGS. 1A and 1B are flowcharts illustrating the overall steps for encryption of the present invention;

FIGS. 2A and 2B are flowcharts illustrating the overall steps for generation of the Hyper Key according to the present invention;

FIG. 3 is a flowchart illustrating the Xor Hyper-Encryption process of the present invention;

FIG. 4 is a flowchart illustrating the Bit Scramble Hyper-Encryption process of the present invention;

FIG. 5 is a flowchart illustrating the Null Bit Padding Hyper-Encryption process of the present invention;

FIG. 6 is a flowchart illustrating the Xor Decryption process of the present invention;

FIG. 7 is a flowchart illustrating the Bit Scramble Decryption process of the present invention;

FIG. 8 is a flowchart illustrating the Null Bit Padding Decryption process of the present invention;

FIG. 9 is a flowchart illustrating how a Crypt file is Authenticated and Prepared for the Decryption processes of the present invention;

### DETAILED DESCRIPTION OF PREFERRED EMBODIMENTS

The present invention is an encryption algorithm that is useful for protecting digital information. More specifically, the present invention is a Many Time Pad (MTP) encryption algorithm that is used for protecting digital information.

The present invention uses three Key Elements, a 300 Megabyte (True Random Number) TRN table, a 300 Megabyte Hyper-Key ID table (also composed of True Random Numbers), and a Key ID position number. Since there are an extremely large number of possible keys, the invention according to the present invention is a Many Time Pad (MTP) and a Very Many Pad (VMP), which no user could ever exhaust in the time remaining the present cosmic cycle using digital computing. Further, once quantum computing becomes available, the table used in the present invention can be increased to any size required.

The TRN table and Hyper-Key ID table, according to the present invention, are true random numbers which are used to produce hyper-strong pseudo-random numbers. As used in the present application a hyper-strong pseudo random number (HS-PRN) is defined as any number string, produced by some process of calculation, which the Ent Test of Fourmilab cannot distinguish from a True Random Number string. That is to say, any calculated number string possessing a level of randomness equal to that of a true random number.

The Key ID position number is necessary to choose a Hyper-Key Identifier (HKID) number from the Hyper-Key ID table, and the HKID number is necessary to generate the encryption Hyper Keys from the TRN file. The Key ID position number is a number of up to 10 digits having a range of 1-2,400,000,000. Key ID position numbers are selected at random from the message sender's TRN file. The Key ID position number is also a delay measure that is meant to slow down an attacker even if the attacker possesses both the TRN table and the Hyper-Key ID table, either of which is useless without the other. By increasing the length of the Key ID position number, an attacker may be delayed by many years.

Preferably, each correspondent has a dedicated receiver that will receive a Key ID position number and a Crypt Text File ID (CTF ID) number, before each new encrypted message is received. The CTF ID number will also be included as the first field of the first record of an encrypted message (thus linking the Key ID position number to the correct Crypt Text File).

In the present invention the first 8 bytes of the CTF ID is the Correspondent Number and the last 4 bytes is the Message Number. Correspondent files and User Files will be kept on a Key ID writable media, such as a CD Rom, with each such file being labeled with a unique Correspondent or User Number. The writable media must be appendable.

The first record in each Correspondent File will be the correspondent's unique signature consisting of a name (user ID) and password. The second record will be that correspondents Public Key. The third record will be the total number of messages the user has sent to that correspondent. All other records will consist of a Key ID position number followed by the matching Message Number from the CTF ID.

The first record in each User File will be the user's unique signature consisting of a name (user ID) and password. The second record will be that user's Private Key. The third record will be the total number of messages the user has sent to all correspondents. All other records will consist of a Key ID position number followed by the matching Correspondent Number and Message Number from the CTF ID.

This allows messages sent to and received from correspondents to be kept on a hard drive in their encrypted form, eliminating the need to save clear text messages, and keeps messages protected in the event that an attacker gains access to the user's computer.

The CTF ID number identifies a correspondent and his message to the system, allowing the system to access his specific file. A signal from the dedicated receiver will alert a correspondent to expect an incoming message. The signal includes a key ID position number and CTF ID number every time a new message is transmitted. The TRN table and the Hyper-Key ID table need only be sent once to each corespondent prior to sending the first message. Preferably, these two tables should be sent by different channels and they should be encrypted, such as with public key encryption before transmission. More preferably, however, the Key ID table should be copied to CD Rom and physically delivered to each correspondent. After they are received, the Key ID table should be kept on the writable media only, with the TRN table being installed on the user's hard drive. The user should keep the writable media on his person or some equally secure place when not in use.

According to the present invention, the results of any given process of calculation that yields a number string of statistically significant length may be subjected to a Digital Culling Process (DCP) to extract HS-PRN strings, regardless of the specific process of calculation employed.

According to the present invention, a string of 256 bytes is produced and subjected to the Ent Test of Fourmilab. If the Ent test out values fall below the minimum values for 256 byte slices of TRN's generated by atomic decay or other processes used in the present invention, the string will be discarded and another string is produced.

Only 256 byte strings that qualify, by being indistinguishable from TRN's, will be retained in the final HS-PRN string produced. Additionally, the entire final HS-PRN string produced will also be subjected to the same test criteria, as a whole, and discarded in toto if it does not qualify.

The following is Fourmilab's description of the functioning of the Ent Test as described by Fourmilab. The program (Ent) applies various tests to sequences of bytes stored in files and reports the results of those tests. The program is useful for those evaluating pseudo-random number generators for encryption and statistical sampling applications, compression algorithms, and other applications where the information density of a file is of interest. Among the values Ent measures are Entropy (in bits per character), Optimum Compression Size, Chi Square Distribution, Arithmetic Mean value of data bytes, Monte Carlo Value for Pi, and Serial Correlation Coefficient.

In the preferred embodiment, the pre-defined criteria for randomness used in the Digit Culling Process are the average values resulting from an analysis for TRNs produced by nuclear decay processes for each of the categories specified in the output results of the Ent Test. (Entropy—7.980627 bits per character or higher; chi square distribution for 256 samples is 237.05, and randomly would exceed this value 75.00 percent of the time; arithmetic mean is approximately 127.45 through 127.55; Monte Carlo value for Pi=3.139648438 or better; serial correlation coefficient is approximately zero).

Any 256 byte bit group that meets these criteria is retained and combined into a single 100 megabyte bit group that must also meet the above criteria as a whole. This 100 megabyte bit group then becomes the Hyper-Encryption Key used in the present invention.

For the purpose of calculating HS-PRN Hyper Keys, a 300 megabyte TRN file is divided into three blocks of 100 megabytes each, and the bits of two of these blocks are placed into two to one correspondence with the bits of the remaining third block. While the length of the TRN file is described herein as 300 megabytes, larger or smaller sizes may be used and still fall within the scope of the present invention.

The third block, a Search Pattern Definition Block, allows the present invention to extract a unique HS-PRN from the first two blocks by dictating which bits will be selected from the respective blocks to create a unique 100 megabyte HS-PRN string.

For example, each bit in each string has a position number between 0 and 799,999,999 inclusive. The present invention treats the bit position number as a single digit in a base 800,000,000 number system, with the position number for the starting bit position in each of the three blocks being one digit in a three digit base 800,000,000 number. The third block is the Search Pattern Definition block, therefore the third digit of three digit number will specify the starting bit position within the SPD block. Likewise, the first digit of three digit number will specify the starting bit position within the first block and the second digit of three digit number will specify the starting bit position within the second block. By choosing different starting bit positions within the SPD block from whence to commence computations, the present invention can generate 800,000,000 unique 100 megabyte Hyper Keys. Additionally, the 800,000,000 different starting positions within the first and second block may be chosen to produce unique Hyper Keys. Finally, since the SPD block is not intrinsically different from the first and second blocks, any of the three blocks may be used as the SPD block, thereby creating additional variability.

As stated before, the present invention treats the starting position numbers for the three blocks as a three digit number of base 800,000,000. Therefore, if a Hyper Key longer than 100 megabytes is required, it is only necessary to increment the starting block digit by one and restart the key generation process to produce 100 more megabytes of Hyper Key bits, or as many additional bits as needed.

In order to generate the above described Hyper Keys, a Hyper-Key Identifier (HKID) is selected. In order to hide the value of the HKID from any third party, the present invention pseudo randomly selects a group of bits from the TRN table to be used as the HKID Position number. Since it is True Random Numbers which are being pseudo randomly selected, the pseudo random nature of the selection process does not diminish the strength of the algorithm.

In the present invention the position of the HKID bits within the Key ID table will not be recorded in the final Hyper Encrypted file, rather it is sent to the dedicated receiver along with a CTF ID, which also appears as the first record in the Crypt file, thus linking the HKID position number to the Crypt file. If the HKID position number (which specifies the starting position of the HKID bits within the Key ID table) is sent the dedicated receiver or other channel it would not appear in the Crypt file. However an alternate embodiment could place it at the beginning of the Crypt file if one wished to avoid the complication of dedicated receivers or other transmission channels. HKIDs are never recorded on the hard drive; they exist only in the Key ID table on the CD ROM, and are located therein using HKID position numbers. Thus an attacker gaining access to one's computer still could not decrypt one's files unless he/she also had possession of the Key ID table CD ROM.

It is possible to select HKID bits in any fashion that allows the Key ID file bits to be interpreted as an HKID number between (0|0|0) and (799,999,999|799,999,999|799,999,999).

In the preferred embodiment, the HKID bits are considered to be strings of Binary Coded Decimal Numbers, with each 4 bits being used to specify one base ten digit. The present invention will select 108 bit sections repeatedly as new keys are needed.

Since the largest digit allowed in the above described example in the first position of the HKID is 7 and not 9, any 4 bit value in that position exceeding 7 will be discarded, and the present invention will move on to extract the next 4 bit block. If any of the other sub-blocks in the HKS digits is greater than 9, the present invention will move on to read the next 4 bit section. This process is carried out until 3 base 800,000,000 digits with the digit ranges of zero through 799,999,999 are extracted to be used as the HKID.

After every such HKID position has been used and each of the three TRN blocks have been used as the SPD, the present invention will use a pseudo-random number generator resident in the program to generate new HKID's, and it will store these new HKID's in a separate table, checking each new HKID so generated to insure that it has not been used before and discarding any that have been used previously. After every possible HKID has been used the present invention will retire the TRN and Key ID tables, using them only for decryption of files that were Hyper-Encrypted using them in the past. A new Key ID and TRN table will then be used in this same way for future encryptions until they have also exhausted every possible HKID within them.

Due to the extremely large number of 100 megabyte Hyper Keys that can be specified by any given TRN table, it is highly unlikely that any given user could ever even exhaust the HKID's specified by the bits in the first Key ID table to be used, and equally unlikely that the computer's pseudo random generator will ever be needed for HKID selection.

An example generation of the Hyper Keys is as follows:

Take for example an HKID of (1,27,796): This indicates that the first bit in the first block is examined; the 27^{th} bit of the second block is to be examined and the 796^{th} bit of the SPD block is to be examined (remember that these bits will be either 0 or 1). If the 796^{th} bit of the SPD block is a 0, then the program will copy the first bit of the first block; if the 796^{th} bit of the SPD block is a 1, then the program will copy the 27^{th} bit of the second block. All positions are then advanced by 1 (2,28,797) and examined and recorded according to the above criteria (a 0 in the SPD position indicated recordation of the bit from the first block and a 1 indicates recordation of the bit from the second block). This is repeated until an HS PRN string has been extracted that is equal in length to the data string to be encrypted or the Max length of 8*10⁸ bits is reached. If the data to be encrypted is greater than the max length, then the last HKID digit is incremented by one and the entire process is repeated until the HS PRN string created is the same length as the clear text data. If the starting SPD bit position is 799,999,999, then it will be reset to zero and the second digit of the HKID will be incremented by 1, and if it also should happen to be 799,999,999 it will be reset to zero and the first HKS digit will incremented by one. If all three HKS digits are 799,999,999 then all three will be reset to zero and this process will continue repeating as long as needed to create a Hyper Key of the same length as the clear text data.

The present invention uses Hyper Keys to Hyper Encrypt data utilizing three methods. All three methods of Hyper Encryption use different Hyper Keys. In the case of clear text data of a length greater than 100 Mb, the HKID will be incremented by one after each 100 Mb of key string is produced, and the Hyper-Key generation process will be repeated until the length of the key string equals the length of the clear text string. The starting HKID number used to begin the generation of any given key will be extracted from the Key ID file starting at the bit indicted by the Key ID position number.

In the present invention a file is defined as Hyper Encrypted when a Hyper Key is employed. A Hyper Key is defined as any Key which is the same length as the file being encrypted and is composed of a bit string which is indistinguishable from True Random Numbers by the Ent test of Formilab. One Time Pad encryption is therefore another example of Hyper Encryption as defined by the present invention.

In the present invention three Hyper Encryption methods will be employed to produce three levels of Hyper Encryption. On the first level the clear text file will be Xor Hyper Encrypted (Method 1). In the second level encryption the 1^{st} level crypt file will be Bit Scramble Hyper Encrypted (Method 2). In the third level encryption the 2^{nd} level crypt file will be Null Bit Padding Hyper Encrypted (Method 3). In the present invention Hyper Encryption Methods 1, 2 and 3 are employed in order on encryption levels 1, 2 and 3 respectively.

In an alternate embodiment it could be the user's option to use any or all of these three methods of Hyper Encryption, or any combination thereof with any number of reiterations of these three methods of Hyper Encryption depending on the level of security actually desired by a specific user. This option might not be included because the highest level of security provided by the three methods of encryption used in any combination with any number of reiterations is also much more processor intensive and time consuming than a single method encryption, and for this reason the user may wish to elect to choose greater speed of processing for a given application. Theoretically a single method encryption alone is already quite strong enough to resist any attempt at cracking it using known existing processing power and techniques.

With the advent of Quantum computing the number of encryption methods may be increased, and the Key ID file bits may be used to dictate the number of levels of encryption to be used and the methods to be employed on each level. For example, an embodiment might consider the first field found immediately after the HKID to specify the number of levels of encryption to be employed, and the fields following, to specify which encryption method is to be employed on each corresponding level, thus a 37 in the first field after the HKID would indicate that 37 Hyper Keys will be used to encrypt the Clear Text 37 successive times, and the next 37 fields would specify the number of the method to be employed on each successive level.

The first method of encryption according to the present invention employs the standard Xor Operation in the usual fashion with the very important exception that the first Hyper Key used is the same length as the clear text data. The bits of the clear text and bits of the Hyper Key are placed in one to one correspondence and corresponding bits are Xored to produce a 1st level Hyper Encrypted Text.

To reverse this process the bits of the 1^{st} level Crypt text file and bits of the Hyper Key are placed in one to one correspondence and corresponding bits are Xored to reproduce the original Clear Text file.

The second method of Hyper Encryption is Bit Scramble Encryption. The input file for the process will be the 1^{st} level Crypt text file.

First, a Hyper-Key will be generated, as previously described. The file to be encrypted is placed in a one to one correspondence with the bits of the Hyper-Key. The Hyper-Key dictates where bits of the file to be encrypted will be placed in the new Crypt file. For example, when a bit of the Hyper-Key is a zero, the corresponding bit in the file to be encrypted will be copied to the end of the new 2^{nd} level Crypt text file. Correspondingly, when a bit of the Hyper-Key is a one, the corresponding bit in the file to be encrypted will be copied to the beginning of the new Crypt text file. This process continues to the end of the file being encrypted to produce the 2nd level Crypt text file where the bits of the input file have been totally scrambled.

To reverse this process and decrypt the second level encrypted Crypt file, the second Hyper-Key is then read backward and where a bit is one the first bit of the Crypt file is copied to the beginning of the decrypted file and the 1^{st} bit of the encrypted file is deleted and where the bit is a zero the last bit of the encrypted file will be copied to the beginning of the decrypted file and the last bit of the encrypted file is deleted. This process will continue until the beginning of the Hyper-Key string is reached, at which time the bits of the Crypt file will have been un-scrambled back to their original configuration.

The third method of Hyper Encryption is ‘Null Bit Padding Hyper Encryption’. The input file for the process will be the 2^{nd} level Crypt text file, the output file will be the 3^{rd} level Crypt text file.

In this process, the input file is read bit by bit starting at the beginning of the file. Where a zero bit occurs, a one bit will be inserted before it, and where a one bit occurs, a zero bit will be inserted before it until the end of the file is reached. The resulting bit string will then be composed of equal numbers of 1 bits and 0 bits, half of which will be null bits. The output file will be twice the length of the input file. The output file will then become the input file for a second method Bit Scramble Encryption (done as described previously). The resulting output Crypt file will have equal numbers of 0 bits and 1 bits with their positions randomly scrambled relative to their previous positions in the input file.

To reverse this process and decrypt a 3^{rd} level Crypt text file the method for decrypting a Bit Scramble Encryption (as described previously) is first employed, then starting with the first bit of the resulting file, every odd numbered bit is deleted, after which the 3^{rd} level Crypt text file will have been placed back into its original configuration.

The algorithm has been fully described. Variable length objects, such as lengths of fields, sizes of files and acceptable value ranges for fields may be varied from the above description and still fall within the scope of the present invention.

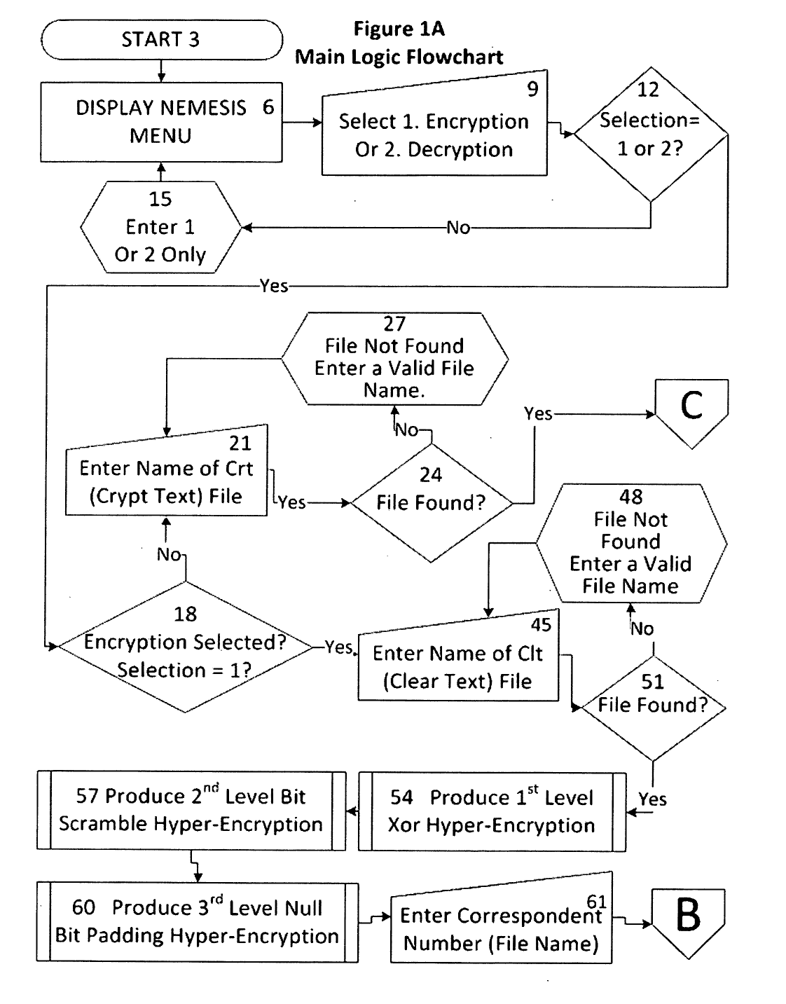

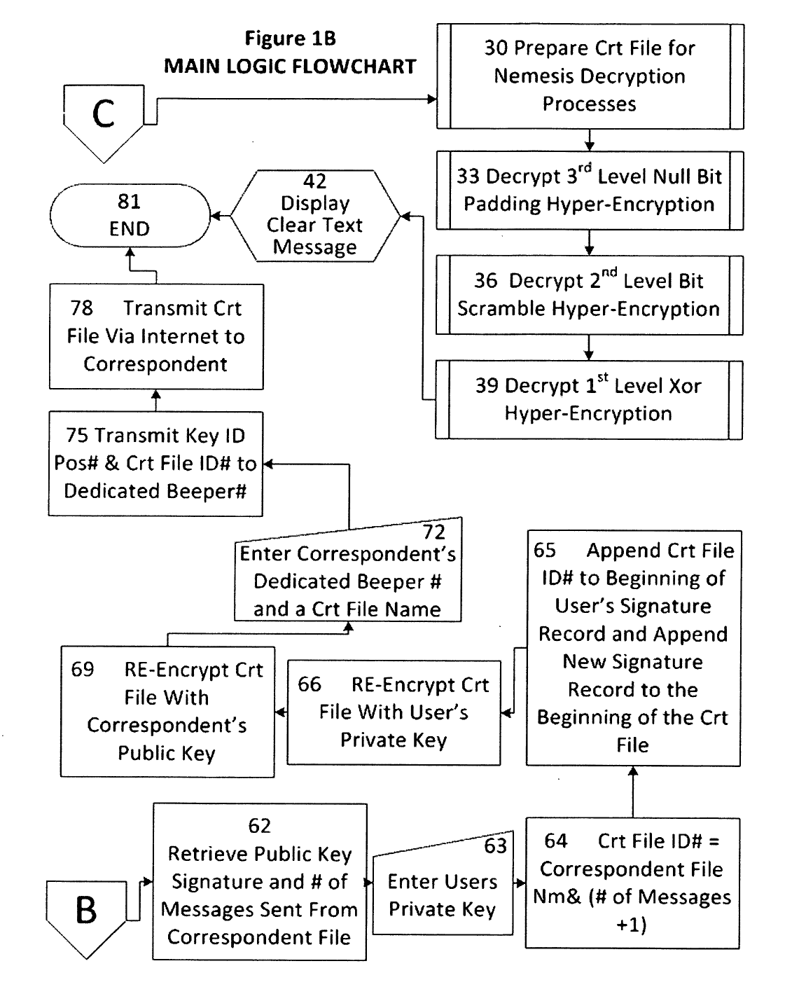

With regard to FIG. 1, which is a main logic flowchart for a program embodying the present invention, once the program is started in Block 3, the program displays a Menu in Block 6, allowing the user to enter ‘Encryption’ or ‘Decryption’ in Block 9. After the selection has been entered the validity of the entry is checked in Block 12. If an invalid entry has been made the program branches to Block 15 which displays the message “Enter 1 or 2 only” and then returns the program to Block 12. If a valid entry is made the program then branches to Block 18 which determines which selection was made.

If decryption is selected then the program branches to Block 21 where the user is prompted to enter the file name of the Crypt Text to be decrypted. The program then proceeds to Block 24 where the program checks to see if a valid Crypt Text file name has been entered. If the Crypt Text file name is invalid Block 27 displays the message “File Not Found Enter a valid file name”, and the program returns to Block 21.

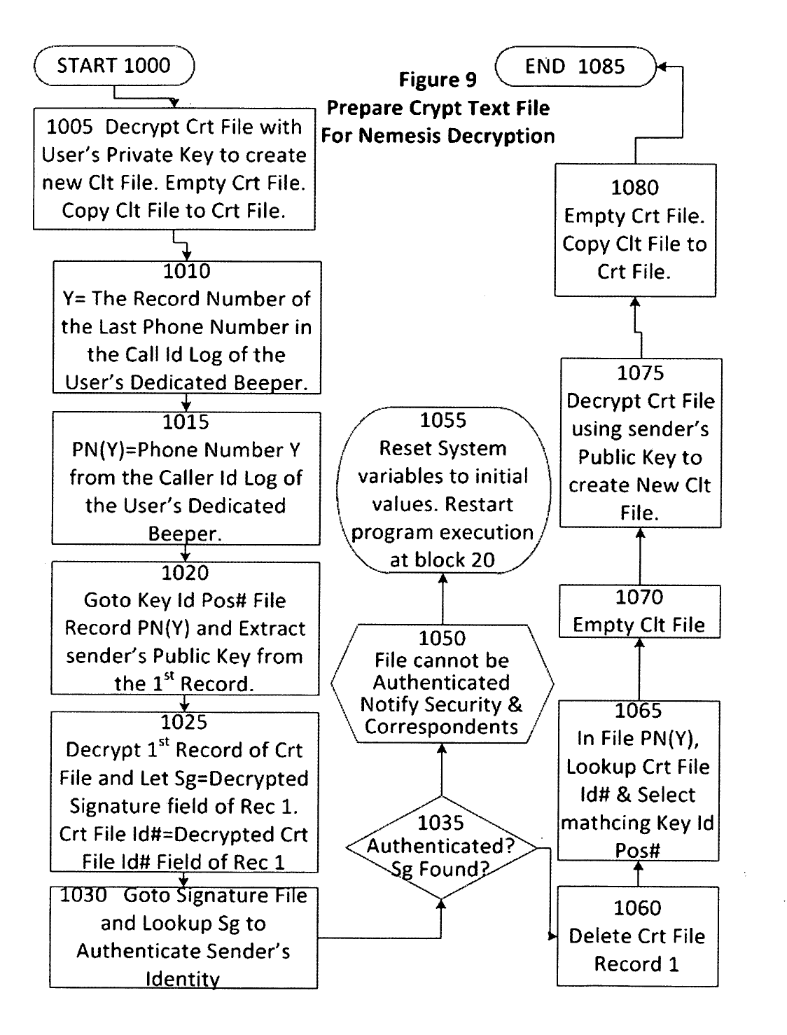

If the Crypt Text file name is valid, the program goes to Block 30 where the Crypt Text file (which at this point is a third level “Null Bit Padding Hyper-Encryption”) is prepared for subsequent decryption processes. Block 30 is a process block with the process being described in detail in FIG. 9.

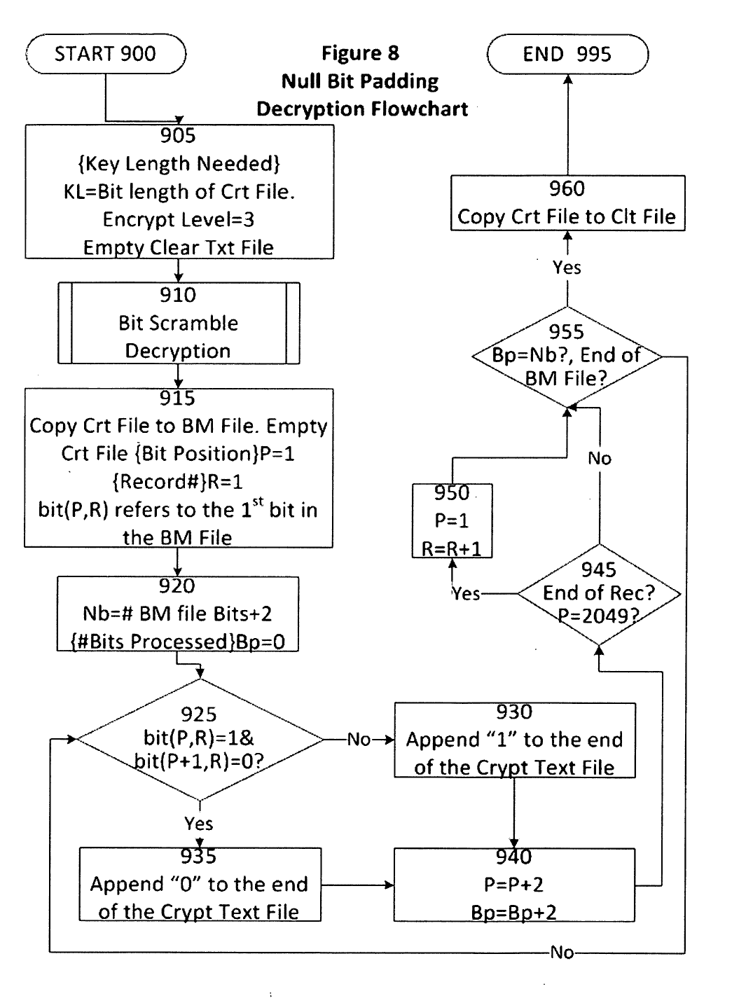

The program then proceeds to Block 33 where the third level “Null Bit Padding Hyper-Encryption” is decrypted revealing the second level “Bit Scramble Hyper-Encryption”. Block 33 is a process block with the process being described in detail in FIG. 8.

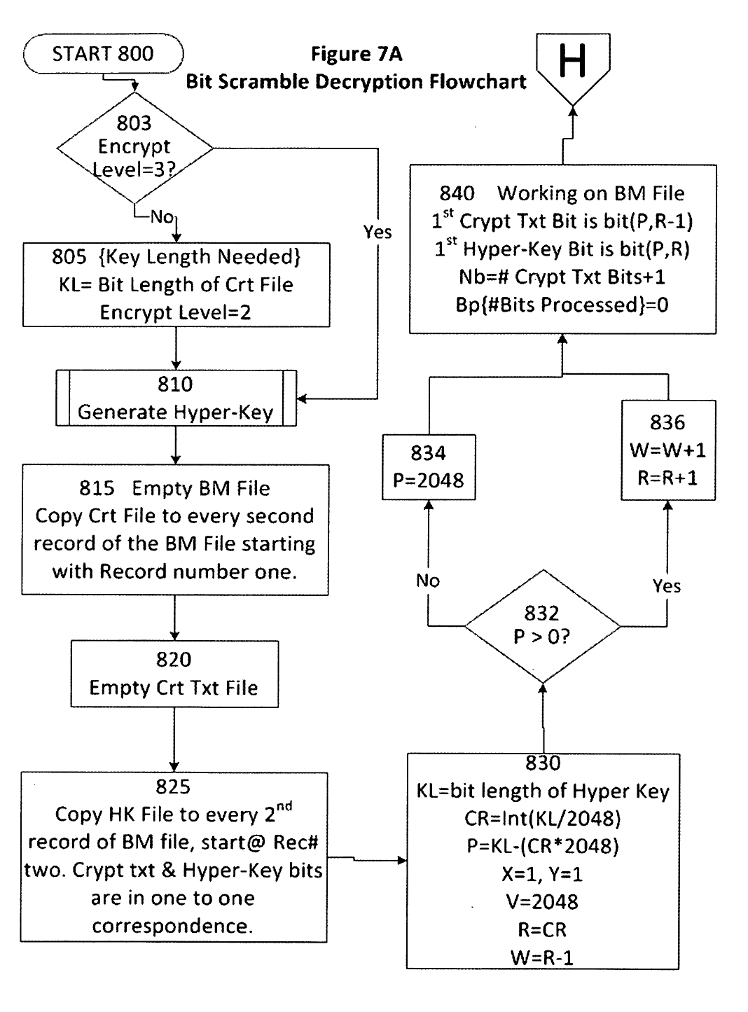

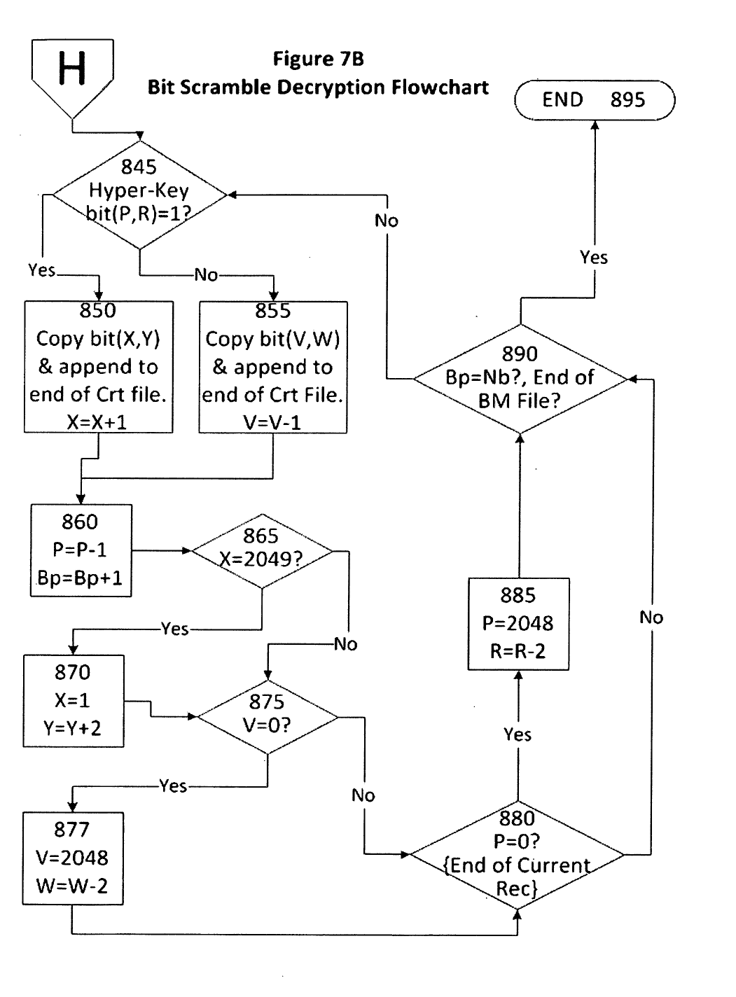

The program then proceeds to Block 36 where the second level “Bit Scramble Hyper-Encryption” is decrypted revealing the first level “Xor Hyper-Encryption”. Block 36 is a process block with the process being described in detail in FIG. 7.

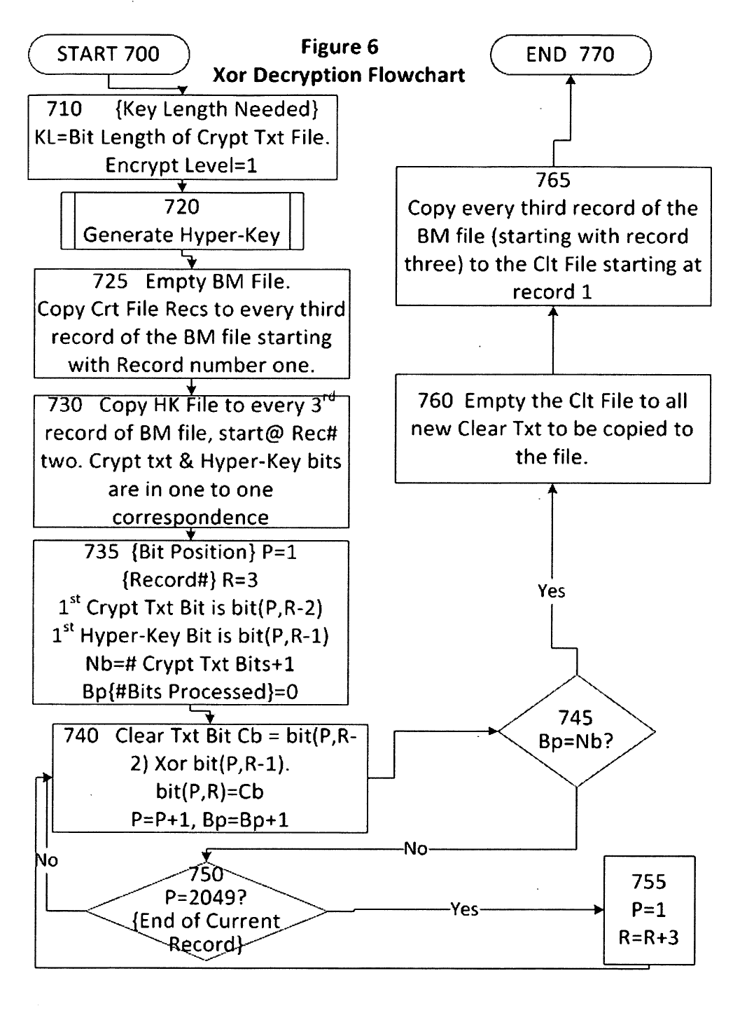

The program then proceeds to Block 39 where the first level “Xor Hyper-Encryption” is decrypted revealing the original Clear Text message. Block 39 is a process block with the process being described in detail in FIG. 6.

The Clear Text message is then displayed in Block 42, and program execution ends in Block 81.

If it is determined in Block 18 that encryption has been selected, the program then branches to Block 45 where the user is prompted to enter the file name of the Clear Text file to be encrypted. The program then proceeds to Block 51 where the program checks to see if a valid Clear Text file name has been entered. If the Clear Text file name is invalid Block 48 displays the message “File Not Found Enter a valid file name”, and the program returns to Block 45.

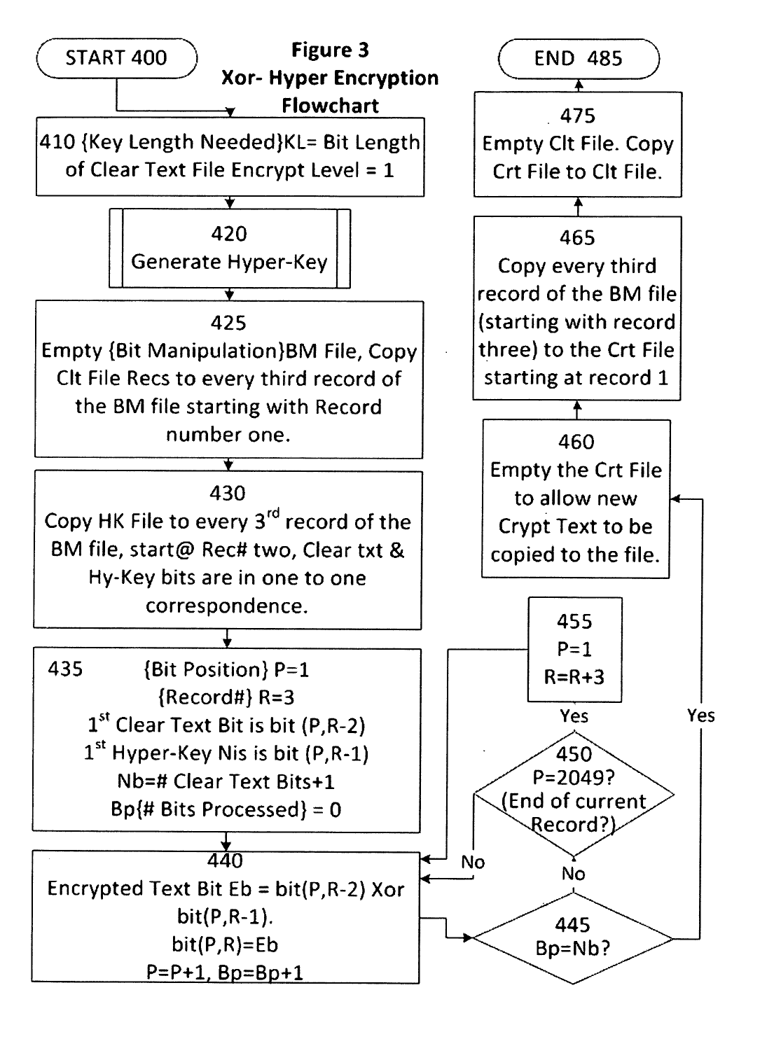

If the Clear Text file name is valid, the program then proceeds to Block 54 where the first level “Xor Hyper-Encryption” is created from the Clear Text message. Block 54 is a process block with the process being described in detail in FIG. 3.

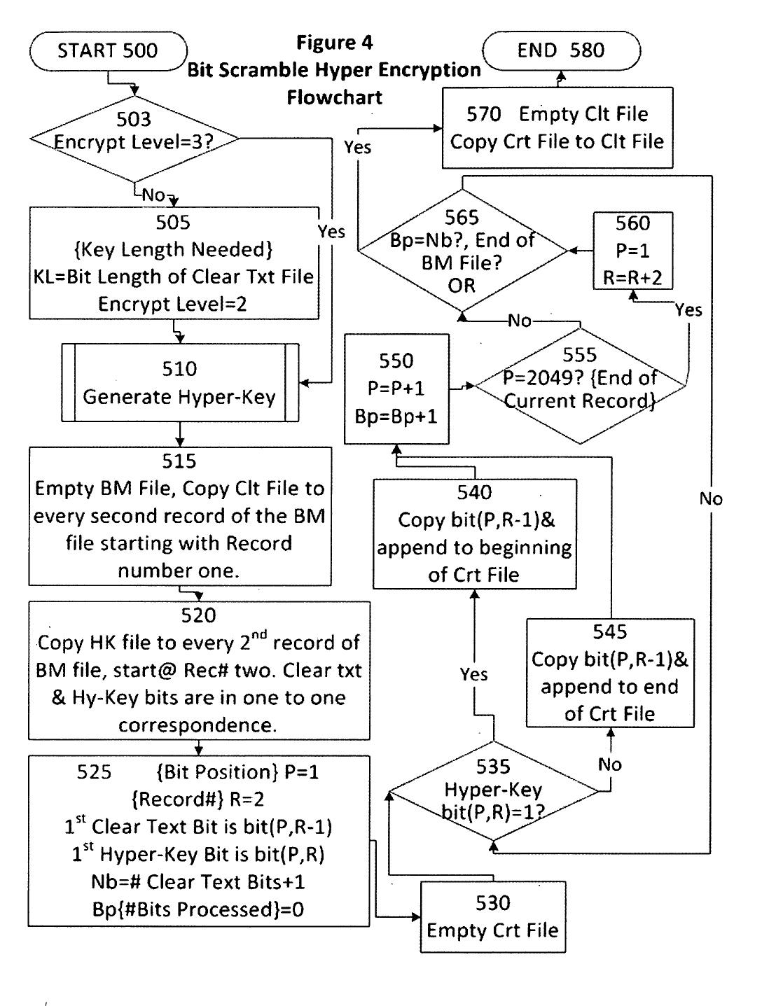

The program then proceeds to Block 57 where the second level “Bit Scramble Hyper-Encryption” is created from the first level “Xor Hyper-Encryption”. Block 57 is a process block with the process being described in detail in FIG. 4.

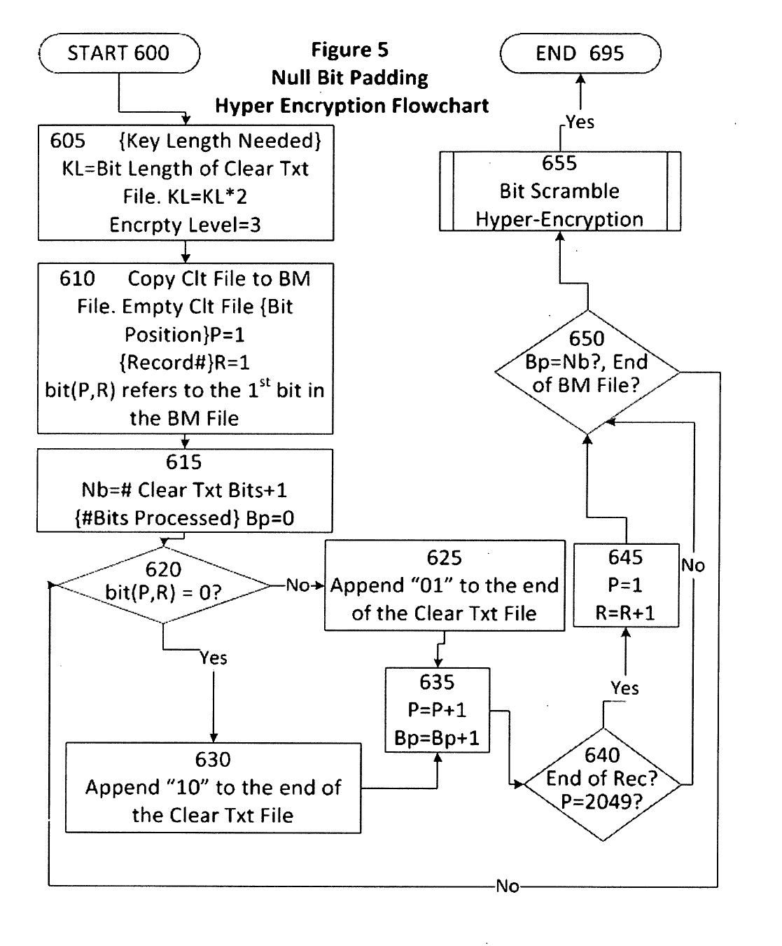

The program then proceeds to Block 60 where the third level “Null Bit Padding Hyper-Encryption” is created from the second level “Bit Scramble Hyper-Encryption”. Block 60 is a process block with the process being described in detail in FIG. 5.

The program then proceeds to Block 61 where the user is prompted to enter the number of the correspondent which the Crypt Text message will be sent to. No error check is associated with this entry, or any further entries in the main logic, because an error check would allow an attacker with access to the user's computer to more easily discover valid entries by the trail and error method. The program then proceeds to Block 62 where the correspondent number is used to identify the applicable correspondent file and the correspondent's Public Key, Signature and Number of Messages Sent thus far, are retrieved. In Block 63 the user is prompted to enter his Private Key (both the user and his correspondents are required to have some form of public key encryption system such as ‘Pretty Good Privacy’ installed on their computers).

In Block 64 The Crypt File Id number is set equal to the Correspondent Number with the Number of Messages Sent (to that correspondent)+1, appended to it. In Block 65 the Crypt File Id number is appended to the beginning of the user's Signature record and the resulting new record is appended to the beginning of the Crypt File as the Crypt File Signature record.

In Block 66 the Crypt File is then Re-Encrypted with public key encryption utilizing the user's Private Key. In Block 69 the Crypt File is Re-Encrypted with public key encryption utilizing the correspondent's Public Key.

In Block 72 the user enters the correspondent's dedicated receiver, such as a beeper number, and a name for the newly created Crypt File which will be transmitted. In Block 75 the program transmits the Key Id Pos number and the Crypt File Id number to the correspondent's dedicated receiver. In Block 78 the Crypt File is transmitted via the internet to the correspondent, and program execution ends in Block 81.

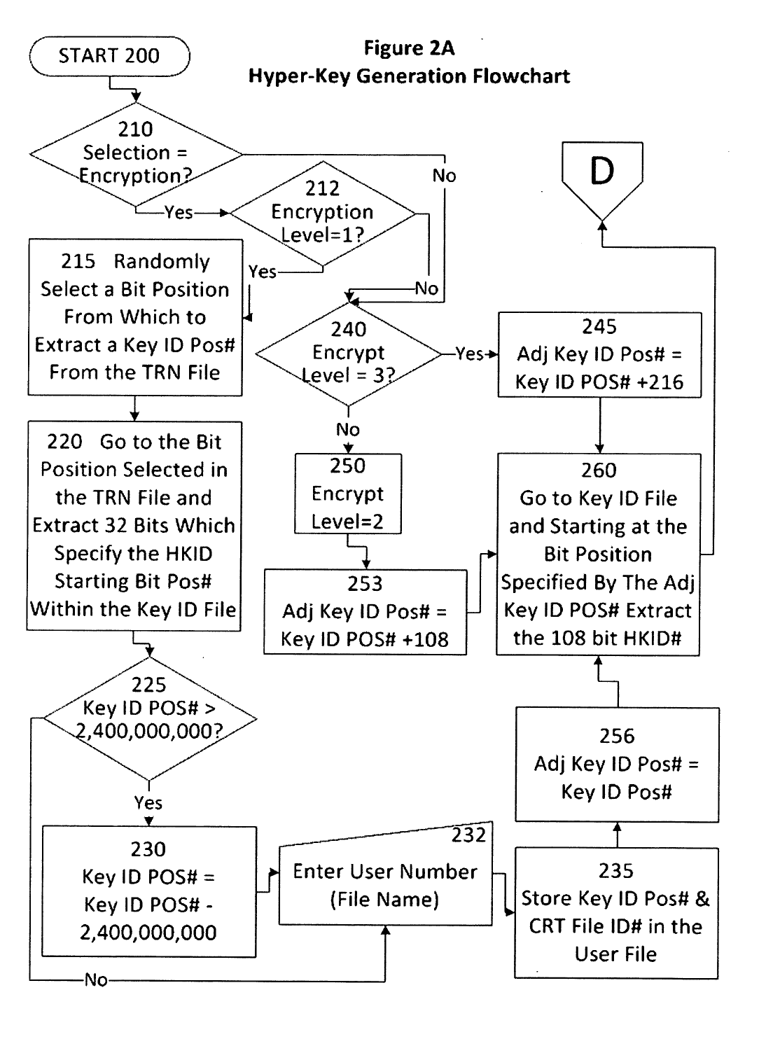

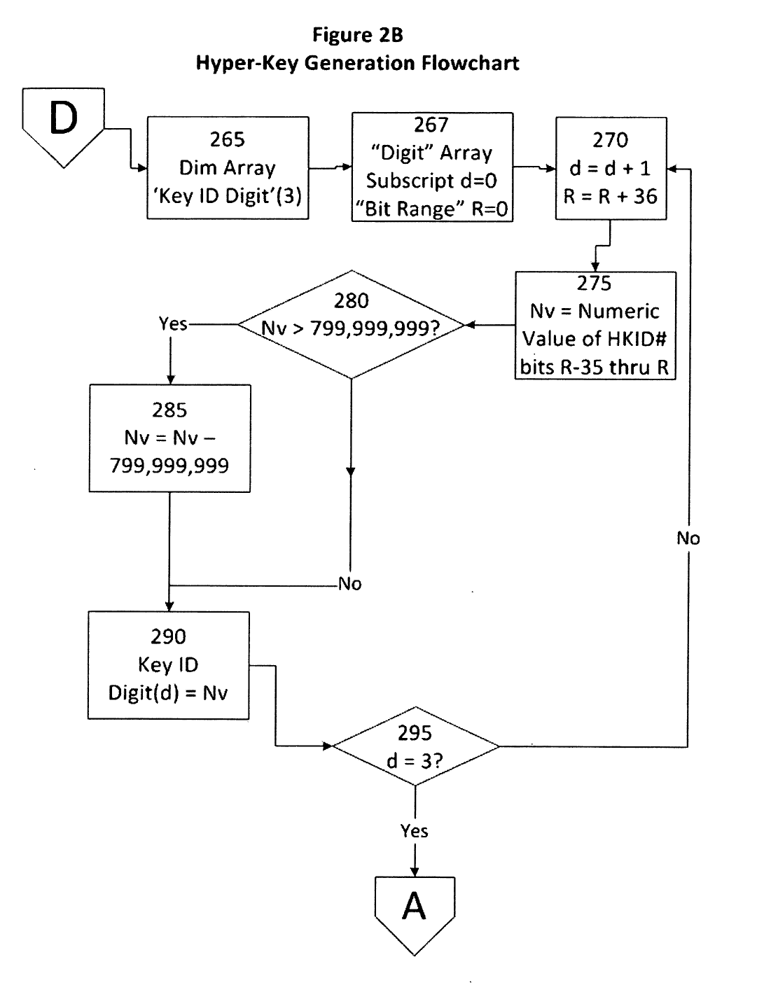

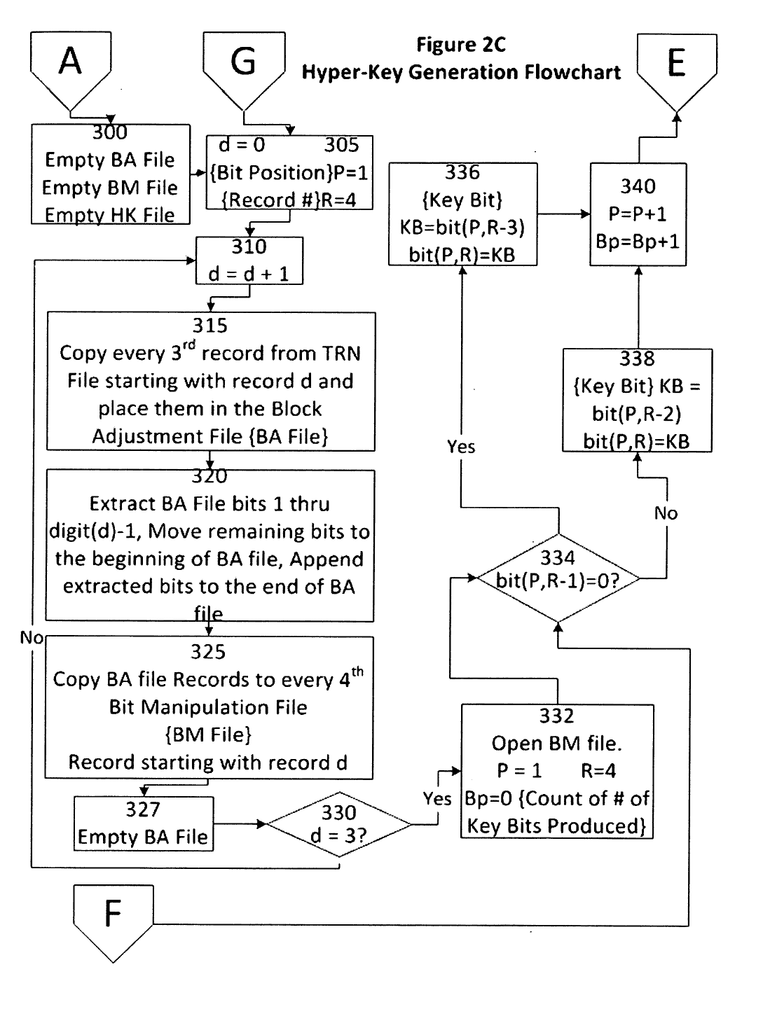

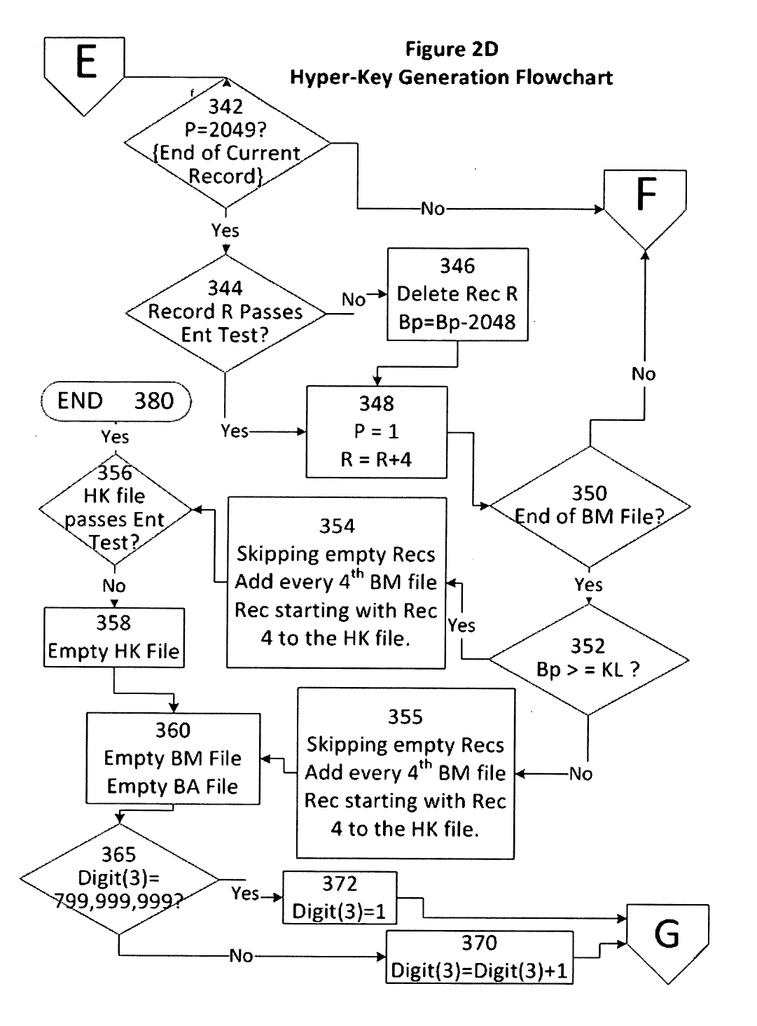

With regard to FIG. 2, which is the logic flowchart for the Hyper-Key Generation processes employed in the present invention, once this subroutine is started in Block 200, program execution then proceeds to Block 210 where it is determined if a new Hyper-Key is being generated to encrypt a new Clear Text File, or if a previously generated Hyper-Key must be reproduced to decrypt a previously encrypted file. The ‘Selection’ variable was set to ‘Encryption’ or ‘Decryption’ in the main logic of Flowchart 1. The “level” is set by the sub-routine which called the Hyper-Key Generation sub-routine.

In Block 210, if Selection=“Encryption” the program proceeds to Block 212, where the encryption level is determined. In Block 212, if level=1 program execution continues in Block 215 where the pseudorandom number generator resident in the computer is used to select a bit position (with a range of 1-2,400,000,000), within the True Random Number file, from which to extract a Key Id Position number. If in Block 210 Selection equals “Decryption” or if in Block 212 the Encryption Level had not been equal to 1, then the program proceeds directly to Block 240.

In Block 220, starting at the position previously selected in Block 215, the program copies the 32 bits from the TRN file which are used to specify the Hyper Key starting bit Position number within the Key Id file. These bits are stored in the “Key Id Pos number” system variable.

Next in Block 225 it is determined if the Key Id Pos number is within the acceptable pre-determined range. If it is not in range the program proceeds to Block 230 where it is adjusted to fall within the acceptable range of 1-2,400,000,000, if it is in range the program continues execution in Block 232 where the user is prompted to enter his/her user number, which together with the incremented Message Number from the user file, will be used as the file name (Crt File ID number) of the new Crypt text file to be generated. The Msg number is the second field of the last record of the user file and specifies how many messages the user has encrypted, being incremented by one each time a new message is produced. Then in Block 235 the Key ID Pos number is appended to the Crt File ID number and stored as the new last record in the User File and proceed to Block 256.

In Block 240 it is determined if the Encryption Level is equal to 3, if yes then in Block 245 the Adjusted Key Id Position number is set equal to the Key Id Pos number plus 216, so that the HKID number for level three encryption may be extracted from the Key Id File. The HKID number for each level of encryption is 108 bits long. Starting at the Key Id Pos number in the Key Id File the first 108 bits are the HKID number for Level one encryption, the second 108 bits are the HKID number for Level two encryption and the third 108 bits are the HKID number for Level three encryption; thus if we add 216 to the Key Id Pos number we get the starting bit position of the Level three HKID number.

If it is determined in Block 240 that the Encryption Level is not 3 then the program proceeds to Block 250 where it is determined if the Encryption Level is 2; if yes then in Block 253 the Adjusted Key Id Position number is set equal to the Key Id Pos number plus 108; if not, then the program continues execution in Block 256 where the Adjusted Key Id Position number is set equal to the Key Id Pos number (since process of elimination dictates Encryption Level 1 at that point).

Blocks 245, 253 and 256 all proceed to Block 260 where the 108 bit HKID number is extracted from the Key Id File starting at the bit position specified by the ‘Adjusted Key Id Pos number’. Then in Block 265 the Array variable ‘Digit’ is created. Digit(d) is used to separate and store the 3 base 800,000,000 digits of the HKID number. Then in Block 267 the subscript variable d of the Digit Array is set to zero, and the ‘Bit Range’ variable R is set equal to zero.

In Block 270 the Digit Array subscript d variable is incremented by 1, and the Bit Range R variable is incremented by 36 (indicating a 36 bit range to be taken as one of three HKID number digits). As stated before the HKID number is composed of three base 800,000,000 digits. These three digits will be stored in the Digit Array Digit(d), with Digit(1) being equal to HKID number bits 1-36, Digit(2) being equal to HKID number bits 37-72 and Digit(3) being equal to HKID number bits 73-108. Block 270 is the beginning of a loop ‘D’ which executes 3 times to accomplish this.

In Block 275 the Numeric Value variable Nv is set equal to HKID number bits 1-36 because R was initialized to a value of 36 in Block 270 (Block 275 is the second block of loop D. The second time Block 275 is encountered R will have a value of 72 [d will equal 2], the third time Block 275 is encountered R will have a value of 108 [d will equal 3]).

In Block 280 the program checks to see if Nv is greater than 799,999,999 (which is the largest digit possible in base 800,000,000). If Nv is greater than 799,999,999 the program proceeds to Block 285 where 799,999,999 is subtracted from the value of Nv, then the program returns to Block 280 where it is determined if the new value of Nv is greater than 799,999,999. This cycling between Blocks 280 and 285 will continue until Nv has a value of 799,999,999 or less at which time the program proceeds to Block 290.

In Block 290 Digit(1) is set equal to Nv because d was initialized to a value 1 in Block 270. (Block 290 is the fourth block of loop D which executes three times. The second time Block 290 is encountered d will have a value of 2; the third time Block 290 is encountered d will have a value of 3). After the third return to Block 290 Digit(1) will equal the value of the first 36 bits of the HKID number, Digit(2) will equal the value of the second 36 bits from the HKID number and Digit(3) will equal the value of the third set of 36 bits from the HKID number. Block 295 decides when to end the loop. If d is not equal to 3 the program proceeds back to Block 270 and loop D executes again. If d is equal to 3 then loop D ends and program execution continues in Block 300 of FIG. 2B.

With regard to FIG. 2B, which is a continuation of the flowchart of the Hyper Key generation process, in Block 300 the Block Adjustment (BA) file is emptied, the Bit Manipulation (BM) file is emptied and the Hyper Key (HK) file is emptied, thus preparing all three files to receive new number strings. The program proceeds to Block 305 where the subscript variable “d” of the Digit array is set to zero, the Bit Position variable P is set to 1 (Variable P is used to keep track of which bits within a record are to be acted upon by the program in any given operation) and the Record Number variable R is set to 4 (variable R is used to keep track of which records are being acted upon by the program in any given operation). Together P and R are used to map a table (database) to a carteasian co-ordinate system where P and R are analogous to standard X and Y co-ordinates respectively. For example if one were to refer to Bit(473,31) one would be referring to the 473^{rd} bit of the 31^{st} record of a given data table.

The program then proceeds to Block 310 where the Digit array subscript variable d is incremented by 1, thus preparing it to be used as an incremental counter. The program then proceeds to Block 315 where every 3^{rd} record of the TRN table (True Random Number table) is copied starting with record d and stored in the Block Adjustment (BA) file. (The method is inside loop d which will execute three times breaking the 300 Mb TRN table into three separate blocks of 100 Mb each.) The program then proceeds to Block 320 where a digit of the Key Id Number is read from Digit(d) and every bit preceding that bit position is moved and appended to the end of the BA file. The resulting BA file will have the bit specified by the digit of the Key ID Number in the first position of the file. The program then proceeds to Block 325 where all BA file records are copied to every 4^{th} record in the BM file (Bit Manipulation File) starting with record d. This places the TRN bits into the correspondence necessary to perform the Search Pattern Operation after 3 loops. Every 4^{th} record in the BM file is left blank so Hyper Key strings resulting from the Search Pattern Operation can be stored there in correspondence with the bits they were produced from. The program then proceeds to Block 327 where the BA file is emptied in preparation for the next iteration of loop d. It next goes to the decision Block 330 where it is determined if d=3, if not the program branches back to Block 310 and loop d continues to execute. If d does equal 3 then loop d ends and the program branches to Block 332.

In Block 332 the program returns to the BM file to commence the key bit generation process, the Bp variable, which stores the number of key Bits Produced, is set to zero in preparation for actual key bit generation, and R (Row) is set equal to 4, which is the first blank record in the BM file, The P (Bit Position) variable is also set to 1. Record 4, R=4, is where the first key bits produced by the Search Pattern Operation (SPO) will be stored. The program then proceeds to Block 334 where the SPO commences.

Block 334 is a decision block which determines if the SPD (Search Pattern Definition) bit in record R−1, at position P, is equal to zero, if it is not equal to zero the program branches to block 338 where the variable KB (Key Bit) is set equal to Bit(P,R−2) and Bit(P,R) is set equal to KB, if it is equal to zero the program branches to Block 336 where the variable KB is set equal to Bit(P,R−3), and Bit(P,R) is set equal to KB. All three bits referenced have corresponding Position numbers, Record R is where the Key Bits produced are stored, Record R−1 is where the true random bits used as our SPD are stored, Record R−2 is where the “One Row” of TRNs is stored and Record R−3 is where the “Zero Row” of TRNs is stored. If the SPD bit is a zero the program will copy the corresponding bit at P in R−3 the “Zero Row” to the corresponding P in R the Key Bit Record, and if the SPD bit is a one the program will copy the corresponding bit at P in R−2 the “One Row” to the corresponding P in R the Key Bit Record.

Both Blocks 336 and 338 proceed to Block 340 where both the Position number P and the Bits Produced number Bp are incremented, allowing the program to keep track of which bits are being acted upon in a given iteration of this P and R loop and the number of Key Bits produced. The program then proceeds to Block 342 which is a decision block that determines if the end of the current record has been reached. If not then the program branches back to Block 334 and begins the next iteration of the loop. If the end of the current record has been reached then the program branches to Block 344 which is a decision block determining if the key string produced thus far passes the Ent Test (which tests the degree of randomness in number strings and has already been described in detail). If the Key String does not pass the Ent Test the program then branches to Block 346 where the failed record R is deleted and the Bp variable has 2048 subtracted from it, 2048 being the number of bits stored in record R. The program then proceeds to Block 348 where P is reset to 1 and R is incremented by 4, thus preparing the program to examine the next group of bits as the loop continues to execute. If the Key String does pass the Ent Test, the program by-passes Block 346 and proceeds directly to Block 348.

From Block 348 the program proceeds to Block 350 which is a decision block determining if the process has reached the end of the BM file. If the end of the BM file has not been reached the program then braches back to Block 334 for another iteration of loop P,R. If the end of the BM file has been reached then the program branches to Block 352 which is a decision block which determines if the number of Key bits produced is greater than or equal to the Key Length needed. The KL (Key Length) value is set by the sub-routines which call the key generation subroutine.

If Bp is >=KL the program branches to Block 354 where every 4^{th} record of the BM File starting with record 4 (the key bit records) is copied to the HK (Hyper Key) file skipping empty records (which were originally filled with bits that failed the Ent Test). The program then proceeds to Block 356 which is a decision block determining if the entire HK file as a whole passes the Ent Test. If it does then subroutine execution ends in Block 380. If the HK file does not pass the Ent Test, program execution continues in Block 358 where the HK file is emptied of all data, then proceeds to Block 360 where the BM and BA files are emptied, in order to prepare these files for use in a new attempt to generate an HK file which passes the Ent Test.

If it is determined in Block 352 that Bp is not >=the required KL, then the program branches to 355 where every 4^{th} record of the BM File starting with record 4 (the key bit records) is copied to the HK (Hyper Key) file, skipping empty records. The program then proceeds to Block 360 where the BM and BA files are emptied allowing a new round of key bit generation. Program execution continues in Block 365 which is a decision block which determines if Digit(3) is equal to 799,999,999 (the largest digit in base 800,000,000).

If Digit(3)=799,999,999 the program branches to Block 372 which sets the array variable Digit(3)=1. The program then proceeds back to Block 305 where another iteration of the Hyper-Key subroutine commences. If Digit(3) is not equal to 799,999,999 the program branches to Block 370 where Digit(3) is incremented by 1. The program then proceeds back to Block 305 where another iteration of the Hyper-Key subroutine commences. Reiteration of the Hyper-Key subroutine is necessary when the HK file fails the Ent Test and is discarded, or when the total number of key bits needed exceeds 800,000,000.

With regard to FIG. 3, which is a flowchart of the Xor Hyper-Encryption process, program execution starts in Block 400 and proceeds to Block 410 where KL (Key Length) is set equal to the bit length of the Clt (Clear Text) file, and the Encryption Level is set= to 1. The program then proceeds to Block 420, a process block which calls the Hyper-Key Generation subroutine. From Block 420 program execution continues in Block 425 where the BM file is emptied, and the Clear Text file is copied to every third record in the BM file starting with record 1. The program then proceeds to Block 430 where the HK file is copied to every third record of the BM file starting with record 2. The bits of the Clear Text and the bits of the Hyper-Key are now in one to one correspondence allowing them to be Xor-ed in sequence.

The program then proceeds to Block 435 where the Position variable P is set equal to 1. P specifies the position of a bit being operated on within a given file record. The Record Number variable R is set equal to 3. R specifies the file Record where the bit being operated on resides. Together P and R are used like X and Y to map a Cartesian co-ordinate system on the bits of any file. Nb is set equal to the number of clear text bits+1. Bits processed Bp is set equal to zero. According to the present mapping the first clear text bit stored in the BM file is bit(P,R−2), the first Hyper-Key bit stored in the BM file is bit(P,R−1), and the first Encrypted bit Eb will be bit(P,R).

The program then proceeds to Block 440 where Eb (Encrypted Bit) is set equal to BM file bit(P,R−2) Xor bit(P,R−1), then Eb is stored in bit(P,R), P is incremented by 1 and Bp is incremented by 1. Then the program proceeds to Block 445 which is a decision block determining if number of Bits Processed Bp is equal to the number of Bits Needed Nb. If Block 445 returns a yes then program execution continues in Block 460 where the Crt file (Crypt Text file) is emptied to allow a new Crypt text to be copied to the file. The program proceeds to Block 465 where every third record of the BM file starting with record three is copied every record of the Crt file starting with record 1. The program then proceeds to Block 475 where the contents of the Crt file (Crypt text file) is copied to the Clt file (clear text file), thus setting the stage for the next level of encryption. Then subroutine execution ends in Block 485.

If Block 445 returns a no, then the program proceeds to Block 450 which is a decision block which determines if the end of the current record has been reached. If Block 450 returns a yes then the program branches to Block 455 where P is set equal to 1, and R is incremented by 3, in order to advance processing to the beginning of the next record. Then the program returns to Block 440 where the next clear text bit is Xor-ed with the next key bit to produce the next encrypted bit which is in turn stored in bit(P,R), P is incremented by 1, and Bp is incremented by 1. The program then proceeds back to Block 445 where it is again determined if Bp=Nb. If Bp is not equal to Nb the program goes back to Block 450 which determines if the end of this new record has been reached. If Block 450 returns a no, the program returns to Block 440 to Xor the next bits up. Then the program proceeds to Block 445 where is checks to see if Bp=Nb again. This loop will continue to execute until Bp=Nb, at which time the program proceeds through Blocks 460, 465, 475 and to the end Block 485 as previously described.

With respect to FIG. 4, which is a flowchart of the Bit Scramble Hyper-Encryption process, the subroutine starts in Block 500 and then proceeds to Block 503 which is a decision block that determines if the Encryption Level is equal to 3. If the Encryption Level is equal to 3 the program branches to Block 510 where the Hyper-Key generation subroutine is called. If the Encryption Level is not equal to 3 the program branches to Block 505 where the Key Length Needed, KL, is set equal to the bit length of the Clear Text file, and the Encryption Level is set equal to 2. The program then continues to execute in Block 510 where the Hyper-Key Generation subroutine is called. The preceding decision loop is needed because the Bit Scramble Hyper-Encryption subroutine is called by both the Main Logic and the Null Bit Padding subroutine, each of which require different initializations of the same variables.

The program then proceeds to Block 515 where the BM file is emptied, and then every record in the Clear Text file is copied to every second BM file record starting with record 1. The program then proceeds to Block 520 where every HK file record is copied to every second BM file record starting with record 2. The Clear Text bits and the Hyper-Key bits are now in one to one correspondence. Program execution continues in Block 525 where the Bit Position P is set equal to 1 and the Record number is set equal to 2. According to the mapping of the present embodiment the first Clear text bit is bit(P,R−1) and the first Hyper-Key bit is bit(P,R) inside the BM file. The number of bits needed Nb is set equal to the bit length of the Clear Text file and the number of bits processed Bp is set equal to zero. The program proceeds to Block 530 where the Crypt Text file is emptied so that a new Crypt Text file may be generated.

From Block 530 the program proceeds to Block 535 which is a decision block determining if the BM file Hyper-Key bit(P,R) is equal to 1, if it is equal to 1, then the program branches to Block 540 where BM file bit(P,R−1) is copied and appended to the beginning of the Crypt Text file. If Hyper-Key bit(P,R) is not equal to 1 then the program branches to Block 545 where BM file bit(P,R−1) is copied and appended to the end of the Crypt Text file. Both Blocks 540 and 545 lead to Block 550 where the variables P and Bp are incremented by 1. Then the program proceeds to Block 555 which is a decision block determining if the end of the current record has been reached. If the end of the current record has been reached the program proceeds to Block 560 where the Position variable P is reset to 1 and the Record number is incremented by 2, setting the program up to examine the next record. The program then proceeds to Block 565.

If the end of the current record has not been reached the program proceeds directly to Block 565. Block 565 is a decision block which determines if Bp=Bb OR the end of the BM file has been reached. If either condition obtains the program proceeds to Block 570 where the Clear Text file is emptied and the Crypt Text file is copied into the Clear Text file. Subroutine execution then ends in Block 580. If neither condition obtains then the program returns to Block 535 and the bit scramble process continues to loop until either Bp=Nb OR the end of the BM file is reached.

With respect to FIG. 5, which is a flowchart of the Null Bit Padding Hyper-Encryption process, the subroutine starts in Block 600 and then proceeds to Block 605 where the Key Length KL is set to twice the bit length of the Clear Text file (this is necessary because later the program will add a number of null bits to the Clear Text file equal to the bit length of the Clear Text file), and the Encryption Level is set equal to 3. Then the program proceeds to Block 610 where the Clear Text file is copied to the BM file, the Clear Text file is emptied, Bit Position P is set equal to 1, and Record number R is also set equal to 1. Bit(P,R) now refers to the first bit in the BM file. The program then continues to Block 615 where the Number of Bits needed Nb is set equal to the bit length of the BM file+1, and the Number of Bits Processed Bp is set equal to zero.

The program then proceeds to Block 620 which is a decision block that determines if bit(P,R) of the BM file is equal to zero. If BM file bit(P,R) is equal to zero then the program branches to Block 630 where 10 is appended to the end of the Clear Text file, (this has the effect of inserting a 1 to the left of the original zero). The program then proceeds to Block 635 where the Position variable P and the Bits Processed variable BP are both incremented by 1. If BM file bit(P,R) is NOT equal to zero, then the program branches to Block 625 where 01 is appended to the end of the Clear Text file (This has the effect of inserting a 0 to the left of the original 1), and the program proceeds to Block 635 where the Position variable P and the Bits Processed variable BP are both incremented by 1.

The program then proceeds to Block 640 which is a decision block that determines if the end of the current record has been reached. If the end of the record has been reached the program branches to Block 645 where Position number P and the Record number R are both incremented by 1, thus setting up the program to look at the first bit of the next record on the next reiteration of the present loop. The program then proceeds to Block 650 which is a decision block that determines if Bp=Nb OR the end of the BM file has been reached. If the end of the record has NOT been reached the program branches directly to Block 650. If Block 650 returns a YES then the program proceeds to Block 655 which is a process block that calls the Bit Scramble Hyper-Encryption subroutine, then the present subroutine ends in Block 695. If Block 650 returns a NO then the program branches back to Block 620 and the loop reiterates until Bp=Nb OR the end of the BM file is reached.

With regard to FIG. 6, which is a flowchart of the Xor Hyper-Decryption process, the subroutine commences execution in Block 700 and proceeds to Block 710 where the Key Length Needed KL is set to the bit length of the Crypt Text file (also referred to as the Crt file elsewhere), and the Encryption Level (which is also the Decryption Level) is set to 1. The program then proceeds to Block 720 which is a process block that calls the Hyper-Key Generation subroutine which reproduces the correct Hyper-Key to Decrypt the Crt file. The program continues to execute in Block 725 The Bit Manipulation BM file is emptied, and all Crypt Text Records are copied to every third record in the BM file starting at BM record 1.

The program then proceeds to Block 730 where all Hyper-Key HK file records are copied to every 3^{rd} record of the BM file starting at record number 2. The Crypt text and Hyper-Key bits are now in one to one correspondence and ready for the Xor operation. The program continues in Block 735 where the Bit Position variable P is set to 1, the Record number R is set to 3, the Number of Bits needed Nb is set equal to the number of bits in the Crypt Text file+1 and the Number of Bits processed Bp is set equal to zero. The first Crypt Text bit is designated bit(P,R−2) and the first Hyper-Key bit is designated bit(P,R−1).

The program then proceeds to block 740 where the Clear Text Bit variable Cb is set equal to bit(P,R−2) Xor bit(P,R−1), and bit(P,R) is set equal to Cb. The Position variable P is then incremented by 1 and the Bits Processed Bp variable is also incremented by 1. The program then proceeds to Block 745 which is a decision block that determines if Bp is equal to Nb. If Bp=Nb the program proceeds to Block 760 where the Clear Text file is emptied to allow the newly produced clear text to be copied to the file. Program execution continues in Block 765 where every third record of the BM file starting with record 3 is copied to the Clear Text file starting at record 1, thus producing a new Clear Text file. The subroutine then ends execution in Block 770.

If Block 745 determines that Bp is not equal to Nb then the program branches to Block 750 which is a decision block that determines if the end of a record has been reached, if it has not been reached the program proceeds directly back to Block 740 where the next two bits in the BM file are Xored to product the next Cb. If the end of the record has been reached then the program branches to Block 755 where P is set equal to 1 and R is incremented by 3 before the program proceeds back to Block 740 for another Xor operation. From Block 740 program execution continues in Block 745 and this loop continues until the Bits Processed Bp is equal to the Number of Bits needed Nb, at which time the subroutine proceeds through Blocks 760, 765 and ends in Block 770 as previously described.

With regard to FIG. 7, which is a flowchart of the Bit Scramble Hyper-Decryption process, the subroutine commences execution in Block 800 and proceeds to Block 803 which is a decision block determining if the Encryption Level is equal to 3. If it is equal to 3 the program proceeds directly to Block 810. If it is not equal to 3 the program proceeds to Block 805 where the Key Length Needed KL is set equal to the Bit Length of the Crypt Text file, and the Encryption Level is set equal to 2. The program then proceeds to Block 810 which is a process block calling the Hyper-Key Generation subroutine. Execution then continues in Block 815 where the Bit Manipulation BM file is emptied and the Crypt Text file is copied to every second record of the BM file starting in record 1. The program continues in Block 825 where the Hyper-Key file is copied to every second record of the BM file starting in record 2. The Crypt Text and Hyper-Key Bits are now in one to one correspondence. The program then proceeds to Block 830 where the Number of Complete Records CR is set equal to the Integer of the Bit Length of the BM file divided by 2048. Thus CR is set equal to the total number of complete records composing the BM file since each record is 2048 bits in length.

P, the bit position, is then set equal to the number of bits in any last partial record which might exist at the end of the BM file. For the purpose of the subroutine, P must be initialized to the bit position number of the last bit in the last record of the BM file. Variables X, Y, V, W and R are used as co-ordinates in a rectangular co-ordinate system applied to the bit positions within the BM file, with record numbers being equivalent to Y co-ordinates, and bit positions within records being equivalent to X co-ordinates. The X and Y variables are initialized to 1, V is set equal to 2048, R is initialized equal to CR and W is set equal to R+1.

The subroutine continues to execute in Block 832 which is a decision block determining if a last partial record exists at the end of the BM file. According to the formula for initializing P given in Block 830 P will be set to zero if there is no last partial record in the BM file, therefore if P>0 then there is a partial last record and the program proceeds to Block 836 where both W and R are incremented by one to equal the position number of the that last partial record in the BM file. If P is equal to zero then there is no partial last record in the BM file, all records are complete records having 2048 bits each. The program then branches to Block 834 where P is set equal to 2048 which is the bit position of the last bit in any complete record.

Both Blocks 836 and 834 then proceed to Block 840 where Nb, the Number of Bits needed to process is set equal to the total number of Crypt text bits plus 1, and Bp, Bits Processed is initialized to zero. At this time the program is working on the BM file applying a rectangular co-ordinate system wherein bit(P,R−1) is the first Crypt text bit stored in the BM file, and bit(P,R) designates the first Hyper-Key bit stored in the BM file.

The subroutine then proceeds to Block 845 where it is determined if a given Hyper-Key bit is equal to 1. If it is then the subroutine branches to Block 850 where bit(X,Y) of the BM file is copied and appended to the end of the Crypt text file, and X is incremented by 1. The subroutine uses X and Y co-ordinates to walk forward through the bits of the BM file from beginning to end. If the given Hyper-Key bit is not equal to one, then the subroutine branches to Block 855 where bit(V,W) copied and appended to the end of the Crypt text file, and V is decremented by 1. The subroutine uses V and W co-ordinates to walk backward through the bits of the BM file from end to beginning. The Hyper-Key bit values determine which co-ordinates will be used in a given operation.

Both Blocks 850 and 855 proceed to Block 860 where P is decremented by 1 (because the subroutine is walking backwards through the Hyper-Key bits) and Bp, number of bits processed, is incremented by 1. The program then continues to Block 865 which is a decision block determining if the X co-ordinate is equal to the end of record value of 2049. If it is the subroutine branches to Block 870 where X is set equal to 1 and Y is incremented by 2 (walking forward through the Crypt text bits stored in the BM file). The program then proceeds to Block 875.

If in Block 865 X is not equal to 2049, then the program proceeds directly to Block 875 which is a decision block determining if an end of record has been reached (walking backward through the Crypt text bits stored in the BM file). If it has the subroutine branches to Block 877 where V is set equal to 2048 (the last bit position in any given record) and W is decremented by 2 (pointing to the next record to be considered walking backward through the Crypt text bits stored in the BM file). The program then proceeds to Block 880. If in Block 875 V is not equal to zero (end of current record has not been reached) then the program branches directly to Block 880 which is a decision block determining if the end of the current Hyper-Key record stored in the BM file has been reached (walking backward through the Hyper-Key bits).

If end of record has been reached, P=0 then the subroutine branches to Block 885 where P is set equal to 2048 and R is decremented by 2, the subroutine proceeds to Block 890. If end of record has not been reached, then the subroutine branches directly to Block 890. Block 890 is a decision block which determines if all the bits of the BM file have been processed or not. If all bits have been processed the subroutine branches to Block 895 where it ends execution. If all bits have not been processed then the subroutine branches back to Block 845 where the value of the next Hyper-Key bit is extracted and this loop continues to execute until all bits in the BM file have been processed and the Bit Scramble Decryption subroutine execution ends in Block 895.

With regard to FIG. 8, which is a flowchart of the Null Bit Padding Hyper-Decryption process, the subroutine commences execution in Block 900 and proceeds to Block 905 where KL, the key length needed is set equal to the bit length of the Crypt text file, Encrypt Level is set equal to 3 and the clear text file is emptied. The subroutine then proceeds to Block 910 which is a process block which calls the Bit Scramble Decryption subroutine (because after the null bits were added the file was also bit scrambled).

With the bits of the Crypt text file unscrambled the program continues execution in Block 915 where the Crypt text file is copied to the BM file and the Crypt text file is emptied. The bit position, P, is set equal to 1, the record number, R, is also set equal to 1 which means that it(P,R) refers to the first bit of the BM file. Program execution continues in Block 920 where the number of bits to be processed, Nb, is set equal to the number of BM file bits plus 2 and the number of Bits processed is initialized to 0.

The program then proceeds to Block 925 which is a decision block which determines if the first two bits in the BM file are “10”. In the null padding encryption process original bits were flipped and the flipped bit was added to the left of the original bit. If the two bits under consideration are “10” then the left bit is padding and the right bit is information bearing. The subroutine branches to Block 935 where the right bit is appended to the end of the Crypt text file (which was emptied earlier). If the two bits under consideration are not “10” they must be “01” (because the left bit is the right bit flipped), where 0 is padding and 1 is information bearing. The program then branches to Block 930 where 1 is appended to the end of the Crypt text file.

Both Blocks 935 and 930 proceed to Block 940 where Position, P, is incremented by 2 and Bits processed, BP is incremented by two. The subroutine continues to execute in Block 945 which is a decision block determining if the end of a record has been reached. If the end of a record has been reached the program branches to Block 950 where P is reset to 1 and R is incremented by 1 and then proceeds to Block 955. If the end of a record has not been reached Block 945 branches directly to Block 955.

Block 955 is a decision block which determines if the end of the BM file has been reached. If it has not been reached the subroutine then branches back to Block 925 and this loop executes until end of file is reached. If the end of the BM file has been reached the subroutine branches to Block 960 where the Crypt text file is then copied to the Clear text file. Subroutine execution then ends in Block 995.

With regard to FIG. 9, which is a flowchart of the Prepare Crypt Text File for Nemesis Decryption process, the subroutine commences execution in Block 1000 and proceeds to Block 1005 where the Crypt File is decrypted using the user's private key to create a new Clear Text File, the Crypt Text File is emptied and the Clear Text File is copied to the Crypt Text File. The program then proceeds to Block 1010 where Y is set equal to the record number of the last phone number in the caller Id Log of the user's dedicated beeper. The subroutine then proceeds to Block 1015 where PN(Y) is set equal to the Phone Number Y in the caller Id Log of the User's dedicated beeper. The program then proceeds to Block 1020 where the sender's public key is extracted from the Key Id Position Number File and proceeds to Block 1025 where the first record of the Crypt file is decrypted using the sender's public key, Sg is set equal to the signature field of the first Crypt File record and the Crypt File Id# is set equal to the decrypted Crypt File Id# Field of the first Crypt File record.

The program then proceeds to Block 1030 where the Signature file is looked up to determine if the senders signature, Sg, is authentic. The subroutine then continues to Block 1035 which is a decision block determining if the sender's signature was authenticated. If the signature is not authenticated program execution branches to Block 1050 which displays the message “File cannot be authenticated notify security and correspondents. The program continues to Block 1055 where all system variables are reset to initial values and the program is restarted in Block 20. If the signature is authenticated then the subroutine branches to Block 1060.

In Block 1060 record one of the Crypt file is deleted and the program continues to Block 1065 where the Crypt file Id# is looked up in file PN(Y) and the matching Key Id Pos# is extracted. Continuing in Block 1070 the Clear Text File is emptied. The subroutine then proceeds to Block 1075 where the Crypt File is decrypted using the sender's public key to create a new Clear Text File. The subroutine then continues to Block 1080 where the Crypt Text file is emptied and the Clear Text File is copied to the Crypt Text File, thus leaving the Crypt Text File ready for decryption. The subroutine then ends execution in Block 1085.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method for encrypting a clear text comprising the steps of:
a. providing a computer;
b. using the computer to provide a very large True Random Number table (TRN table);
c. using the computer to provide a very large Hyper-Key Identification table (Hyper-Key ID table), also comprised of True Random Numbers;
d. using the computer to provide a randomly selected Key Identification position number (Key ID position number), said Key ID position number comprising no more than 10 digits having a range of 1-2,400,000,000;
e. on the computer, using the Key ID position number to choose a Hyper-Key Identification (HKID) number from the Hyper Key ID table;
f. on the computer, using the HKID to generate Hyper Keys from the TRN table;
g. using the computer to provide a clear text message to be encrypted;
h. on the computer, using a Hyper Key of the same length as the clear text to be encrypted, Xor Hyper Encrypting the clear text file and the Hyper Key to produce a first level Crypt text file;
i. using a second Hyper Key of the same length as the first level Crypt text file to be encrypted, Bit Scrambling the first level Crypt text file and the second Hyper Key to produce a second level Crypt text file; and
j. using the second level Crypt text file, Null Bit Padding the second level Crypt text file to produce a third level Crypt text file.

2. A method for decrypting a the third level Crypt text generated using the method of claim 1 above comprising the steps of:
a. using the computer to delete every odd numbered bit to recreate the second level Crypt text file;
b. using the computer to reverse the order of the second Hyper-Key and Bit Scrambling the reversed second Hyper-Key and the second level Crypt text file to recreate the first level Crypt text file;
c. using the computer to Xor the first Hyper Key to the first level Crypt text file to recreate the clear text file; and
d. using the computer to read the recreated clear text file.
